(19) United States
(12) Patent Application Publication
(10) Pub. No.: US 2011/0034146 A1
(43) Pub. Date: Feb. 10, 2011

(54) Method for Reporting an Emergency Situation by Mobile Data Communication to a Database

(75) Inventor: Luca Tognola, Oberrohrdorf (CH)

Correspondence Address: BRIAN ROFFE, ESQ, 8170 McCormick Boulevard, Suite 223, Skokie, IL, 60076-2914, US

(73) Assignee: PARATUS AG, WINDISCH (CH)

(21) Appl. No.: 12/936,792

(22) PCT Filed: Apr. 1, 2009
(86) PCT No.: PCT/EP09/02368

§ 371 Date: Oct. 25, 2010

(30) Foreign Application Priority Data
Apr. 8, 2008 (CH) 00546/08

(51) Int. Cl. H04W 4/22

(52) U.S. Cl. 455/404.2

(57) ABSTRACT

The invention relates to a method for reporting an emergency situation or the like by mobile data communication to a database, wherein a mobile telephone having an alarm button is used. After actuating the alarm button on the mobile telephone, data such as photos, videos, sounds, location identification, etc. are recorded and transmitted to the database. Said data are then accessed by a location and, depending on the evaluation thereof, at least one corresponding assistance service, particularly the police, a security agency, an ambulance, or the like is mobilized. An additional button can be selected as a contact button, by which potential danger is reported and the data are registered at the database at least temporarily. If the danger is heightened, the alarm button can be actuated and the assistance service subsequently mobilized.

The invention relates to a method for reporting an emergency situation by mobile data communication to a database according to the preamble to Claim 1.

It is known from U.S. Pat. No. 7,091,866 to report a dangerous situation using a mobile telephone equipped with a camera and an alarm button by means of which one can transmit a photo to a pre-determined police or security agency mail address and an audio signal can be generated.

The object forming the basis of the present invention is to propose a method of the type specified at the start with which the seriousness of the emergency situation can be better assessed, and the action taken by the database location optimised, even as prevention.

This object is achieved according to the invention by a method with the features of Claim 1.

Preferred further embodiments of the method according to the invention form the subject matter of the dependent claims.

With the method according to the invention, not only with an acute threat can an alarm be triggered and photos, films, sound, location identification etc. be recorded and transmitted to the database, but action can also be taken with a potential danger, and escalation can be avoided in the preventive sense.

In a threatening situation the alarm button of the mobile telephone is actuated. It should also be possible to actuate this alarm button when the mobile telephone is locked; the telephone does not have to be unlocked first. By means of the in-built camera the application takes a photo or a series of photos of the person acting in a threatening manner. Instead of one or a number of photos, a film or other specific “characteristics” (e.g. image of the brain waves) could also be recorded with corresponding sensors and supplied as data. The data recorded are transmitted immediately to the database via the mobile provider by means of mobile data communication (SS7 channel, GRPS, UMTS, EDGE etc.).

According to the invention, the mobile telephone display offers a choice of at least two, and preferably three options. These can be identified, for example, by the terms “ALARM”, “CONTACT” and “OBSERVER”.

With an acute threat the “ALARM” option is selected. Via the mobile telephone the alarm is accessed and examined by a location receiving such to emergency calls, and following evaluation at least one assistance service is offered, this service possibly being the police, a security agency, an ambulance or the like.

This location can be, for example, an alarm control unit where the alarm is received and the position of the mobile telephone user (the victim) is detected by means of mobile antennae in the proximity of the mobile telephone. The person concerned is called immediately by the alarm control unit. If said person can not answer the call, the police is alerted, for example, and informed of the location of the occurrence. The person concerned can cancel the alarm status at any time by naming or entering the password.

An alarm could alternatively also be triggered by means of an automatic telephone and/or video telephone connection of the mobile telephone to the location examining the incoming data (alarm control unit).

After pressing the alarm button on the mobile telephone an acoustic signal can also sound as a type of countdown in order to remind the person concerned of the passing of this interval of time.

In order to prevent the victim from being forced by the offender to divulge the password, two different passwords are provided which are only known to the user of the mobile telephone and the alarm control unit. One resets the alarm status, and the other password confirms the threatening situation, which the offender can not know. Confirmation of the threatening situation results in the police being called in. The alarm status is also automatically triggered if, after initially actuating the alarm button, the mobile telephone user does not select any of the three options within a specific interval of time.

If there is no longer an acute threat, but the mobile telephone user is confronted with a situation which could be dangerous, according to the invention the “CONTACT” option is selected. With this option no direct alarm is triggered by the alarm control unit. The user must reset the contact status within a specific interval of time (e.g. 1 to 5 minutes) by giving a correct password (the two same passwords as with the alarm status apply). If he fails to do this, the alarm is triggered. If despite the fact that the offender has been captured photographically and this has been made known to him by the audio signal, the situation unexpectedly becomes more acute, the alarm can be triggered at any time by pressing the alarm button again.

The third “OBSERVER” option preferably provided can be chosen by the mobile telephone user if he is not directly involved in a threatening situation, but is observing one. In this case a photo is also transmitted to the database, but no alarm is triggered and the mobile telephone user must not provide any further inputs. The point of this option is on the one hand to prevent the escalation of threatening situations for third parties, without becoming actively involved, and on the other hand it can help to throw light on offences.

For reasons relating to data protection the mobile telephone user can not himself observe or download the pictures sent to the database. The pictures can, however, be requested from the alarm control centre.

With the method according to the invention, not only can one prevent or throw light on offences, but in this way one can also report traffic accidents, medical emergencies or other emergency situations. By choosing an appropriate reporting option, the seriousness of the emergency situation can be better assessed, and the action taken by the database location can be optimised.

The alarm button or contact button on the mobile telephone can also be understood to mean touching a touch screen or moving a button, holding the keypress or a double or multiple keypress as a double or multiple click or similar.

The microphone in the mobile telephone, for example, could also be used as the sensor by means of which in particular the voice can be recorded, and from this the recorded data can be sent to the database location.

It is an aim of the invention that due to a possible offender knowing that he will be caught red handed by photos etc., he will be careful, and refrain from an offence in the preventive sense.

Within this context, a person feeling himself to be in danger can deliberately take a photo, unnoticed, because he still does not know whether a dangerous situation will in fact arise. With this type of recording of evidence as a precaution, no signal tone will sound.

1. A method for reporting an emergency situation or the like by mobile data communication to a data base wherein a mobile telephone equipped with an alarm button is used by means of which, after actuating the alarm button, data such as photos, films, sounds, location identification etc. are recorded and transmitted to the database, accessed by a location, and depending on the evaluation thereof, at least one corresponding assistance service, particularly the police, a security agency, an ambulance or the like, is mobilised, characterised in that an additional button can be selected as a contact button, by means of which a potential danger is reported, and the data are registered at the database, at least temporarily, and if the danger is heightened, the alarm button can be actuated, and the assistance service subsequently mobilised.

2. The method according to claim 1, characterised in that the reporting of the potential danger or of an alarm can be cancelled within a specific interval of time by giving a correct password before any action is taken by the database location.

3. The method according to claim 1, characterised in that with an acute threat and a resulting alarm signal, the location examining the incoming data immediately calls back the mobile telephone.

4. The method according to claim 1, characterised in that the observation of a situation threatening to a third party is reported to the database, without the user of the mobile telephone taking part in further handling of this report.

5. The method according to claim 1, characterised in that the position of the mobile telephone user is detected by means of mobile antennae in the proximity of the location found upon triggering the alarm button or the contact button or by a navigation system built into the mobile telephone, the mobile telephone with a built-in navigation system automatically establishing the location upon actuation of the alarm or contact button and this being transmitted to the location.

6. The method according to claim 1, characterised in that after actuation of the alarm button the different alarm, contact and observer options are offered for selection on the mobile telephone display.

7. The method according to claim 5, characterised in that non-selection of one of the options following actuation of the alarm button results in the database location taking action.

8. The method according to claim 1, characterised in that upon triggering an alarm, an automatic telephone connection of the mobile telephone with the location examining the incoming data is established.

9. The method according to claim 2, characterised in that after the alarm button is pressed on the mobile telephone an acoustic signal sounds as a type of countdown in order to remind the user of the passing of this interval of time.

10. The method according to claim 2, characterised in that the observation of a situation threatening to a third party is reported to the database, without the user of the mobile telephone taking part in further handling of this report.

11. The method according to claim 2, characterised in that after actuation of the alarm button the different alarm, contact and observer options are offered for selection on the mobile telephone display.

12. The method according to claim 3, characterised in that after actuation of the alarm button the different alarm, contact and observer options are offered for selection on the mobile telephone display.

13. The method according to claim 4, characterised in that after actuation of the alarm button the different alarm, contact and observer options are offered for selection on the mobile telephone display.

14. The method according to claim 2, characterised in that upon triggering an alarm, an automatic telephone connection of the mobile telephone with the location examining the incoming data is established.

15. The method according to claim 3, characterised in that upon triggering an alarm, an automatic telephone connection of the mobile telephone with the location examining the incoming data is established.

16. The method according to claim 4, characterised in that upon triggering an alarm, an automatic telephone connection of the mobile telephone with the location examining the incoming data is established.

17. The method according to claim 5, characterised in that upon triggering an alarm, an automatic telephone connection of the mobile telephone with the location examining the incoming data is established.

18. The method according to claim 6, characterised in that upon triggering an alarm, an automatic telephone connection of the mobile telephone with the location examining the incoming data is established.

19. The method according to claim 7, characterised in that upon triggering an alarm, an automatic telephone connection of the mobile telephone with the location examining the incoming data is established.
